(19) United States
(12) Patent Application Publication
(10) Pub. No.: US 2008/0063249 A1
(43) Pub. Date: Mar. 13, 2008

(54) RADIATION IMAGE RECORDING APPARATUS

(75) Inventor: Yuzuru OHTSUKA, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/854,189

(22) Filed: Sep. 12, 2007

(30) Foreign Application Priority Data
Sep. 12, 2006 (JP) 2006-246718

(51) Int. Cl. G06K 9/00

(52) U.S. Cl. 382/131

(57) ABSTRACT

A radiation image recording apparatus comprises: a carrier holding section having a holding frame consisting of two or more frame members that are adjustable in intervals, the holding frame holding a recording carrier, which is to be used, of recording carriers shaped as a flat plate having two or more sizes on which a radiation image is accumulated and recorded, and a first moving mechanism that moves the holding frame in an in-plane direction in which the recording carrier extends; a second moving mechanism that moves the holding frame in the in-plane direction; a first control section that controls the first moving mechanism so that the recording carrier is disposed in a predetermined position on the carrier holding section; and a second control section that controls the second moving mechanism so that radiation emitted from a radiation projection apparatus is projected to the recording carrier.

### BACKGROUND OF THE INVENTION

1. Field of the Invention

The present invention relates to a radiation image recording apparatus for accumulating and recording a radiation image on a recording carrier by irradiation of a radiation carrying an image.

2. Description of the Related Art

Hitherto, there is known an accumulative fluorescent material wherein a part of the radiation energy is accumulated when the radiation is projected, and it emits light on an accelerated phosphorescence basis in accordance with the accumulated radiation energy when visible light and the like are projected. Recently, there is widely used in a medical field and the like a computed radiography (CR) in which a radiation image is visualized in such a manner that a radiation transmitted through the subject is projected onto an accumulative fluorescent material so as to accumulate and record the radiation image, and an excitation light is projected onto the accumulative fluorescent material and the accelerated phosphorescence light emitted from the accumulative fluorescent material is read.

As for CR for the medical treatment, there are widely used a built-in type of image reading apparatus (hereinafter, it is simply referred to as a built-in device) wherein IP (imaging plate) in which an accumulative fluorescent material extends on the surface of the substrate is accommodated in one device together with a reading section for projecting laser beams to the IP and reading accelerated phosphorescence light, and a radiation is projected onto IP in the state that IP is accommodated in the device, and a cassette type of image reading apparatus (hereinafter, it is simply referred to as a cassette device) wherein IP is accommodated in a portable type of cassette, the cassette which accommodates therein IP storing a radiation image through a photography is detachably mounted, and IP is taken out in the cassette and the radiation image is read.

It is possible to take a picture of a built-in device again by quickly discovering mistake in taking a picture because it is possible to confirm it by reading the radiation image taken a picture at once in the place. Thus, the built-in device is widely used by the mass medical examination and the like from which it is requested to take a picture of the radiation image of a lot of subject surely. According to the conventional built-in device, the subject is compelled to move by self to the photographic position in which IP is installed. Japanese Patent Application Laid Open Gazette TokuKai. 2000-19665 discloses a technology in which an image taking section automatically moves to the position of an image taking site in such a manner that a radiation tube for emitting a radiation, and the image taking section equipped with IP and an image sensor, are operated in synchronism with one another to turn the radiation tube to a desired image taking site. According to the technology disclosed in Japanese Patent Application Laid Open Gazette TokuKai 2000-19665, it is possible to surely take a desired site of picture without forcing an impossible pose on the subject.

On the other hand, according to the cassette device, when taking a picture, a cassette can be easily moved to the image taking site of the subject. Thus, it is possible to take a picture of a desired image taking site without forcing an impossible pose on the patient. In addition, in the event that IP is damaged, the IP accommodated in the cassette can be easily exchanged for a reverse IP. Thus, time and the cost that will cost by the time taking a picture is restarted can be suppressed greatly.

As mentioned above, the built-in device and the cassette device have a different advantage respectively. Accordingly, it often happens that the hospital and the like are provided with both types of image reading apparatus, and it is general that they are used properly in accordance with the usage.

As to the built-in device, in the event that IP cannot be used owing to damage and life-time, there is a need that the IP is exchanged by an engineer of makers, or the built-in device is newly bought. This involves problems that it takes a lot of time and the cost is increased. In this respect, in view of the fact that IP used in the built-in device is basically same as IP used in the cassette device, it is thought that accommodating IP for the cassette device in a built-in device and using it are desirable.

However, in the event that the size of IP for the cassette device is larger than the size of the accommodation section where IP in a built-in device is accommodated, it cannot accommodate IP in a built-in device. Reversely, in the event that the size of IP is considerably smaller than the size of the accommodation section, the position of IP accommodated in a built-in device shifts from the position where the radiation is projected, and it is impossible to take a picture of a desired image taking site.

### SUMMARY OF THE INVENTION

In view of the foregoing, it is an object of the present invention to provide a radiation image recording apparatus capable of recording a radiation image wherein a desired image taking site is photographed, regardless of the size of the recording carrier.

To achieve the above-mentioned objects, the present invention provides a radiation image recording apparatus comprising:

a carrier holding section having a holding frame provided with two or more frame members that are adjustable in intervals, the holding frame holding a recording carrier, which is now to be used, of recording carriers shaped as a flat plate having two or more sizes on which a radiation image is accumulated and recorded, and a first moving mechanism that moves the holding frame for holding the recording carrier in an in-plane direction in which the recording carrier extends;

a second moving mechanism that moves the holding frame in the in-plane direction;

a first control section that controls the first moving mechanism so that the recording carrier held by the holding frame is disposed in a predetermined position on the carrier holding section; and

a second control section that controls the second moving mechanism so that radiation emitted from a radiation projection apparatus for projecting a radiation toward the carrier holding section is projected to the recording carrier held by the holding frame.

According to the radiation image recording apparatus of the present invention, the recording carrier, which is held by an adjustment of the intervals of the holding frame, is moved to a predetermined position on the carrier holding section, and the carrier holding section is moved to a position which meets the projection position of the radiation emitted from the radiation projection apparatus. This feature makes it possible to hold a various sizes of recording carrier. Even if a small size of recording carrier is held, a position of the recording carrier is set to the projection position of the radiation. Thus, it is possible to surely obtain a radiation image of a desired image taking site.

In the radiation image recording apparatus according to the present invention as mentioned above, it is preferable that the recording carrier has a grip frame that is to be griped by a hand when the recording carrier is mounted on or removed from the holding frame, and that the holding frame holds the grip frame of the recording carrier.

Usually, it is general that the recording carrier to be accommodated in a cassette has a grip frame that is to be griped by a user's hand when the recording carrier is exchanged. Holding of the grip frame of the recording carrier by the holding frame makes it possible to avoid such an inconvenience that the holding frame blocks the recording area of the recording carrier. Thus, it is possible to efficiently accumulate and record the radiation image by using the recording area in its entirety.

In the radiation image recording apparatus according to the present invention as mentioned above, it is preferable that the first moving mechanism is provided on a back side of a recording surface on which the radiation image is accumulated and recorded, of the recording carrier held by the holding frame.

According to the radiation image recording apparatus of the present invention, it is possible to avoid such inconvenience that the first moving mechanism blocks the recording surface.

In the radiation image recording apparatus according to the present invention as mentioned above, it is preferable that the radiation image recording apparatus further comprises an image reading section that reads the radiation image accumulated and recorded on the recording carrier in such a manner that an excitation light is projected onto the recording carrier, and light emitted from the recording carrier is read.

The provision of the image reading section makes it possible to quickly read the radiation image that is accumulated and recorded on the recording carrier, and thereby quickly confirming the condition of diseases or defects.

In the radiation image recording apparatus according to the present invention as mentioned above, it is preferable that the image reading section is provided on a side of a recording surface of the recording carrier held by the holding frame, and is withdrawn to a position wherein the recording surface is not blocked off, while the radiation is projected to the recording carrier.

According to the radiation image recording apparatus according to the present invention, the image reading section is provided on the recording surface side of the recording carrier. This feature makes it possible to read the radiation image with great accuracy. And the image reading section is withdrawn to a position wherein the recording surface is not blocked off, while the radiation is projected to the recording carrier. Thus, it is possible to avoid such an inconvenience that the image reading section is photographed on the radiation image.

### BRIEF DESCRIPTION OF THE DRAWINGS

FIG. 1 is a schematic structural view of individual elements for accumulating and recording a radiation image in a radiation image taking system to which the cassette device is applied.

FIG. 2 is a perspective view of the cassette device.

FIG. 3 is an internal structural view of the cassette device.

FIG. 4 is a schematic structural view of a radiation image taking system to which the built-in device according to an embodiment of the present invention is applied.

FIG. 5 is a functional structural view of the built-in device.

FIG. 6 is an enlarged view of the image reading unit, the moving mechanism, and the driving source, which are shown in FIG. 5.

FIG. 7 is an enlarged view of the IP holding section shown in FIG. 5.

FIG. 8 is a flowchart useful for understanding a series of processing from mounting IP for the cassette device on the built-in device to the start of the photography.

FIG. 9 is a view showing the IP holding section in which IP is not held.

FIG. 10 is a view useful for understanding a mechanism for moving an accommodating section of the built-in device.

### DETAILED DESCRIPTION OF PREFERRED EMBODIMENTS

Embodiments of the present invention will be described with reference to the accompanying drawings.

As for a radiation image reading apparatus for reading a radiation image that is accommodated and stored in IP, there are known a built-in device in which IP is accommodated in one device together with an image reading section, and a cassette device wherein IP is accommodated in a portable type of cassette, the cassette which accommodates therein IP storing a radiation image through a photography is detachably mounted, and IP is taken out in the cassette and the radiation image is read. The present invention relates to a device in which IP for a cassette device is accommodated in a built-in device and is used in the built-in device. Therefore, prior to the explanation of the built-in device which is an embodiment of the radiation image reading apparatus of the present invention, first, there will be explained the general structure of the cassette device.

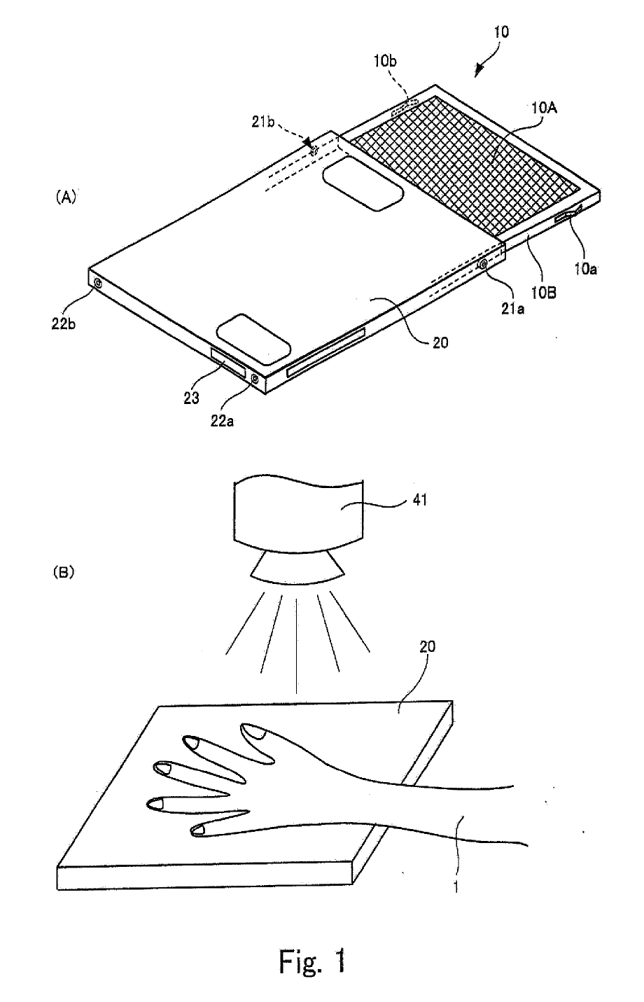

FIG. 1 is a schematic structural view of individual elements for accumulating and recording a radiation image in a radiation image taking system to which the cassette device is applied.

As shown in part (A) of FIG. 1, IP 10 is formed in such a manner that an accumulative fluorescent material 10A is evaporated on a substrate (not illustrated). For the use, the IP 10 is accommodated in a cassette 20 composed of a material which transmits the radiation. The IP 10 is provided with a holding frame 10B for the user to hold it with the hand when the IP 10 in the cassette 20 is exchanged owing to life-time and damage. The IP 10 corresponds to an example of the recording carrier referred to in the present invention. The holding frame 10B corresponds to an example of the holding frame referred to in the present invention.

The holding frame 10B of the IP 10 has plate springs 10a and 10b. When the IP 10 is accommodated in the cassette 20, the plate springs 10a and 10b are engaged with engagement holes 21a and 21b of the cassette 20, respectively, so that the IP 10 is maintained in the cassette 20. On the side opposite to the side in which the IP 10 is inserted, of the cassette 20, there are provided ejection holes 22a and 22b for ejecting the IP 10 by inserting a pin. On the same side as the ejection holes 22a and 22b, of the cassette 20, there is provided a reflective marker 23 in which a size of the cassette 20 is described. When the IP 10 is ejected from the cassette 20, the pin is inserted into the engagement holes 21a and 21b to release the engagement with the IP 10, and then a pin is inserted into the ejection holes 22a and 22b to eject the IP 10 out of the cassette 20.

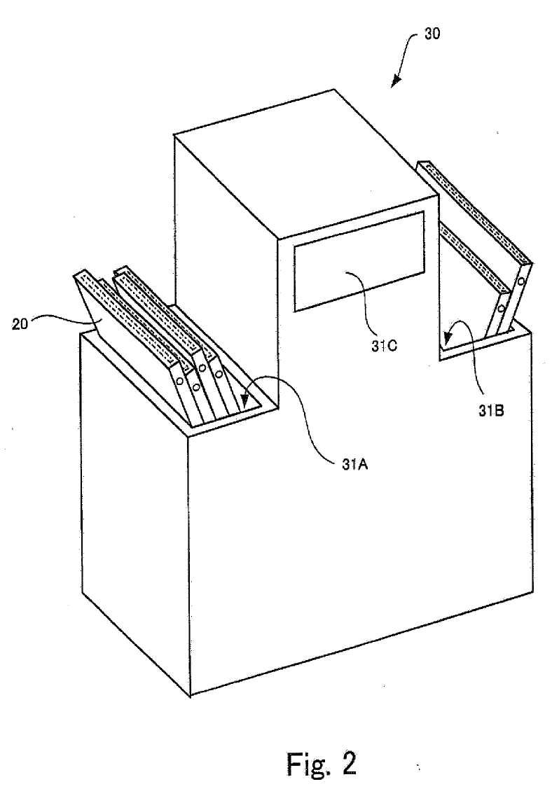

According to a cassette type of radiation image taking system, as shown in a part (B) of FIG. 1, an image taking site of a subject 1 is put on the cassette 20 that accommodates the IP 10, and the radiation is projected from a radiation projection apparatus 41 to the cassette 20. The radiation transmitted through the subject 1 is projected onto the IP 10 in the cassette 20, so that a radiation image is accumulated and recorded on the IP 10. When the photography is over, the IP 10, which is accommodated in the cassette 20, is installed in a cassette device 30 (Refer to FIG. 2) for reading the radiation image.

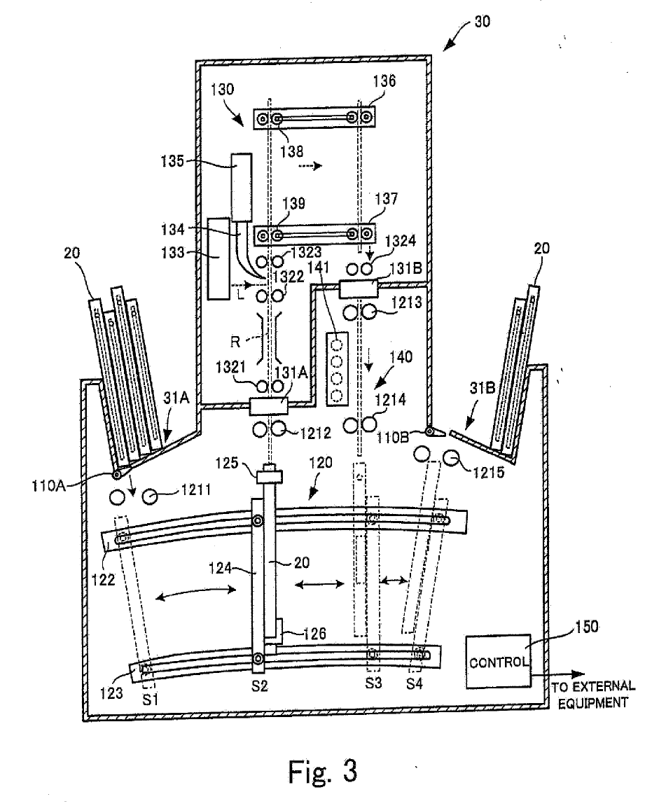

FIG. 2 is a perspective view of the cassette device. FIG. 3 is an internal structural view of the cassette device.

As shown in FIG. 2, at both ends of the cassette device 30, there are provided a carrying entrance 31A, on which the cassette 20 through which the radiation image will be read is loaded, and an outlet 31B through which the cassette 20 subjected to reading of the radiation image is exhausted. At the center of the cassette device 30, there is provided a display panel 31C for displaying the states of operation of the cassette device 30. The cassette device 30 is connected via a network to external equipment (not illustrated) such as a personal computer.

As shown in FIG. 3, the carrying entrance 31A inclines below by going away from the center. A cover member 110A that takes the cassette 20 in the cassette device 30 is set under the inclination. The carrying entrance 31A is provided with a sensor (not illustrated) for reading the reflective marker 23 (refer to FIG. 1) that is provided at the bottom of the cassette 20.

Inside of the cassette device 30, there are provided a conveying section 120 for conveying the cassette 20 between the carrying entrance 31A and the outlet 31B, a reading section 130 for reading a radiation image that is accommodated and recorded on the IP 10 shown in the part (A) of FIG. 1, an erasing section 140 for erasing the radiation image remained on the IP 10, and a control section 150 for controlling operation of the cassette device 30 in its entirety, and for transmitting the radiation image to the external device.

When the reflective marker 23 is read by the above-mentioned sensor and mounting of the cassette 20 is detected, a motor, which is mounted on the cover member 110A of the carrying entrance 31A, is driven to open the cover member 110A in accordance with an instruction from the control section 150, so that the cassette 20 put on the carrying entrance 31A is transported to the conveying section 120 with a conveying roll 1211.

The conveying section 120 comprises: two guide rails 122 and 123 which couple a mounting position Si under the carrying entrance 31A, a reading position S2 under the reading section 130, an erasing position S3 under the erasing section 140, and a discharge position S4 under the outlet 31B with one another; and a conveying member 124 for conveying the cassette 20 between the mounting position S1 and the discharge position S4 by traveling along the guide rails 122 and 123.

The cassette 20, which is conveyed by the conveying roll 1211, is first held by the conveying member 124 at the mounting position S1, and then conveyed along the guide rails 122 and 123 to the reading position S2. At the reading position S2, there are arranged up and down discharge sections 125 and 126 comprising two pins and a solenoid adapted for inserting and drawing those pins. When the cassette 20 is conveyed to the reading position S2, a pin, which is provided on the discharge section 125 of the upper side, is inserted into the engagement holes 21a and 21b of the cassette 20 shown in the part (A) of FIG. 1 to release the engagement of the IP 10 accommodated in the cassette 20, and a pin, which is provided on the discharge section 126 of the lower side, is inserted into the ejection holes 22a and 22b of the cassette 20, so that the IP 10 is ejected from the cassette 20. The IP 10 ejected from the cassette 20 is conveyed by a conveying roll 1212 to the reading section 130. The cassette 20, which is empty where the IP 10 is ejected, is conveyed along the guide rails 122 and 123 to the erasing position S3.

The reading section 130 has a conveying path R extending in a vertical direction. The reading section 130 comprises: shutters 131A and 131B provided at two places, respectively, through which the IP 10 is transmitted; an excitation light irradiation section 133 for projecting an excitation light L in a main scanning direction (a depth direction of the figure); conveying rolls 1322 and 1323 for conveying the IP 10 in a sub-scanning direction (an upper direction of the figure); a condensing guide 134 for condensing an accelerated phosphorescence emission light emitted from the IP 10 to guide it to a photoelectric converter 135; the photoelectric converter 135 for converting the accelerated phosphorescence emission light to an electric signal to read the radiation image that is accumulated and recorded on the IP 10; upper and lower two guide rails 136 and 137 extending in the horizontal direction; and a pair of nip rollers 138 and 139 which move along the guide rails 136 and 137, respectively, to convey the IP 10 in the horizontal direction.

The IP 10 ejected from the cassette 20 is transported forwardly with the conveying roll 1212 and a conveying roll 1321 to the reading section 130. When a leading edge of the IP 10 reaches a position of the excitation light irradiation section 133, the shutters 131A and 131B are closed to shade the reading section 130. The IP 10 is further forwardly conveyed with the conveying rolls 1322 and 1323. While the IP 10 is conveyed, the excitation light L is projected from the excitation light irradiation section 133 to the IP 10 in the main scanning direction. When the excitation light L is projected to the IP 10, the accelerated phosphorescence emission light is emitted from the position, to which the excitation light L is projected, on the IP 10. The accelerated phosphorescence emission light is guided by the condensing guide 134 to the photoelectric converter 135 and is read by the photoelectric converter 135 to create an image signal. When the excitation light L is projected in the main scanning direction (a depth direction of the figure), while the IP 10 is moved in the sub-scanning direction (an upper direction of the figure), the condensing guide 134 receives the accelerated phosphorescence emission light extending in the main scanning direction and introduces the same to the photoelectric converter 135. The photoelectric converter 135 reads the radiation image recorded on the IP 10 for each line extending in the main scanning direction. The thus read radiation image is transmitted to the control section 150 so as to be subjected to image processing such as the shading correction for correcting ununiformity in image density. The radiation image, which is subjected to the image processing, is transmitted to an external apparatus and is saved.

The IP 10, wherein the radiation image is read, is conveyed by the conveying rolls 1322 and 1323 to the nip rollers 138 and 139 so as to be nipped. The nip rollers 138 and 139 move along the guide rails 136 and 137 in the horizontal direction while holding the IP 10. When the nip rollers 138 and 139 reach the edges of the guide rails 136 and 137, the nip rollers 138 and 139 convey the IP 10 downward. The IP 10 is further moved by the conveying rolls 1324 and 1213 downward and is conveyed to the erasing section 140.

The erasing section 140 has a plurality of fluorescent lamps 141 extending in both the main scanning direction (a depth direction of the figure) and the sub-scanning direction (a vertical direction of the figure). When the plurality of fluorescent lamps 141 emit erasing lights Q of the light quantity determined by the control section 150, the erasing lights Q are projected to the IP 10 under transportation. As a result, a radiation energy accumulated in the IP 10 is discharged, and thus the radiation image is erased.

The IP 10, wherein the radiation image is erased, is conveyed further downward by a conveying roll 1214 so as to be accommodated in the empty cassette 20 which has been conveyed to the erasing position S3. The IP 10 included in the cassette 20 is conveyed along the guide rails 122 and 123 to the discharge position S4.

In a similar fashion to that of the carrying entrance 31A, the outlet 31B is also provided with a cover member 110B. When the cassette 20 reaches the discharge position S4, the cover member 110A of the outlet 31B is opened. The cassette 20, which reaches the discharge position S4, is conveyed by conveying rolls 1215 to the outlet 31B and then discharged from the outlet 31B.

The cassette device 30 is composed basically as mentioned above.

The IP 10 is easy to be damaged owing to repetitive irradiation of radiation or laser beams, and also easy to be damaged because the accumulative fluorescent material 10A is evaporated on a hard substrate. According to the cassette device 30 mentioned above, it is possible to easily exchange the IP 10 accommodated in the cassette 20 for a reserve IP, and thereby greatly suppressing time and the cost that will cost by the time taking a picture is restarted.

Next, there will be explained the built-in device in which IP and an image reading section are accommodated in one device. The IP accommodated by the built-in device and the IP 10 for the cassette device 30 have a basically similar structure. Therefore, the part (A) of FIG. 1 will also be applied to the explanation of the built-in device.

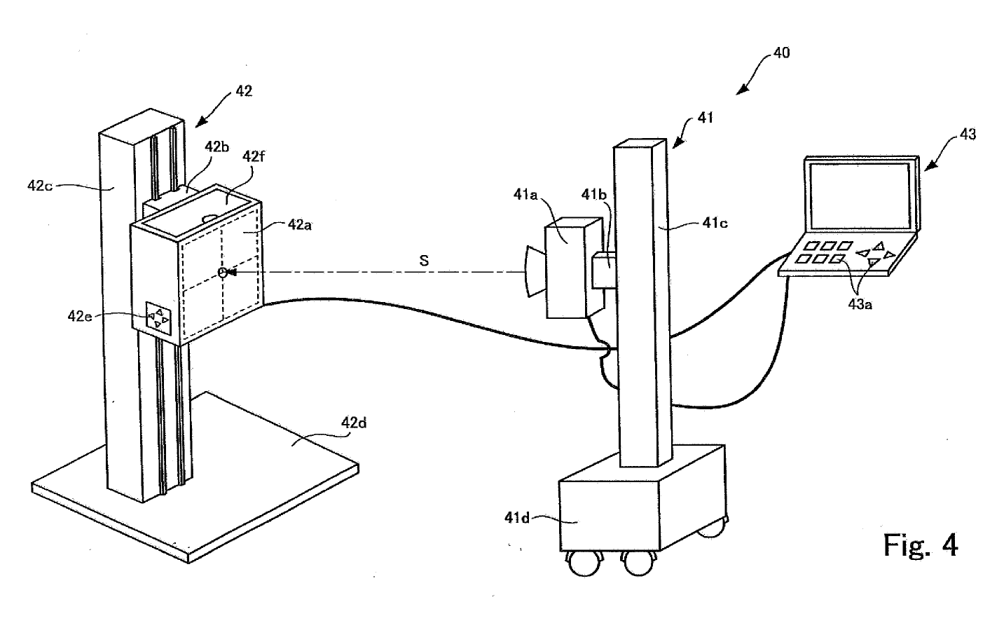

FIG. 4 is a schematic structural view of a radiation image taking system to which the built-in device according to an embodiment of the present invention is applied.

A radiation image taking system 40 shown in FIG. 4 comprises: a radiation projection apparatus 41 for projecting radiation and infrared; a built-in device 42 for accumulating and recording a radiation image on the IP 10 and reading the radiation image; and a control device 43 connected with both the radiation projection apparatus 41 and the built-in device 42, the control device 43 being adapted to display the radiation image read by the built-in device 42 on a monitor and to control operation and positions of the radiation projection apparatus 41 and built-in device 42.

The radiation projection apparatus 41 comprises: an accommodating section 41a for accommodating bulbs which emit radiation and infrared, a moving section 41b for moving the accommodating section 41a in the vertical direction; a supporting section 41c for supporting the accommodating section 41a and the moving section 41b; and an irradiation stand 41d that puts the supporting section 41c. The radiation projection apparatus 41 corresponds to an example of the radiation projection apparatus referred to in the present invention.

The built-in device 42 comprises: an accommodating section 42a for accommodating the IP and an image reading section; a moving section 42b for moving the accommodating section 42a in the vertical direction and the horizontal direction; a supporting section 42c for supporting the accommodating section 42a and the moving section 42b; a photography stand 42d on which the subject is put; and operation buttons 42e for issuing to the moving section 42b an instruction of a moving direction and a moving distance. On the top of the accommodating section 42a, there is provided a cover 42f which may be opened at the time of exchange of the accommodated IP. As to the method of movement of the accommodating section 42a, it will be explained later in detail.

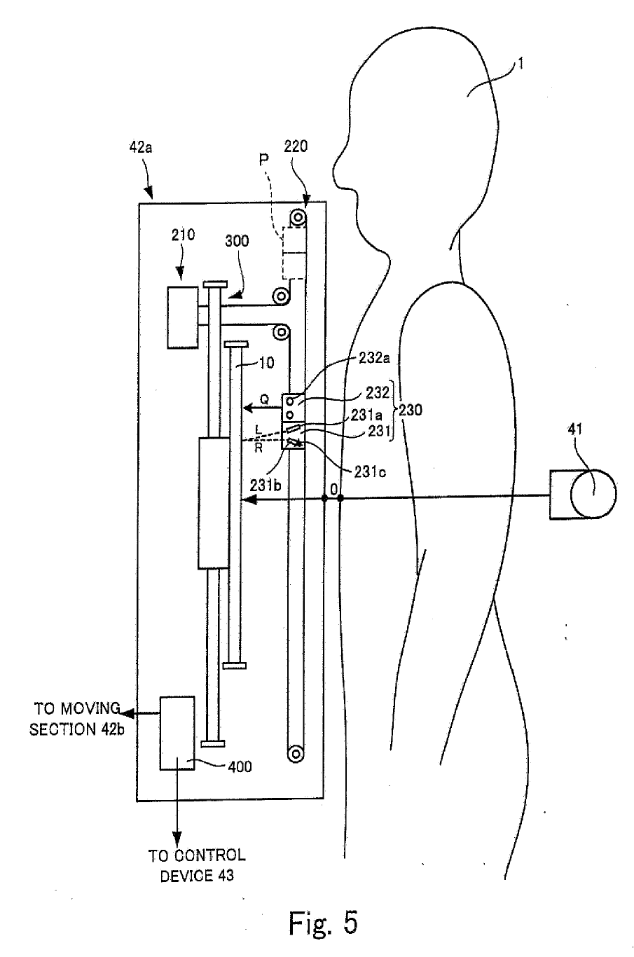

FIG. 5 is a functional structural view of the built-in device 42.

The accommodating section 42a of the built-in device 42 includes: a control section 400 for controlling the built-in device 42 in its entirety; an IP holding section 300 for holding IP 10; an image reading unit 230 for reading a radiation image which is accumulated and recorded on the IP 10; a moving mechanism 220 for moving the image reading unit 230 in the vertical direction; and a driving source 210 for applying a driving force to the moving mechanism 220. According to the present embodiment, the accommodating section 42a is able to accommodate therein IP of two or more sizes. The control section 400 stores sizes (width and length) of the IP of two or more sizes and migration lengths in the vertical direction to set the center of direction of length of the size IP to the position where the radiation is applied, in their association. The control section 400 corresponds to an example of both the first control section and the second control section.

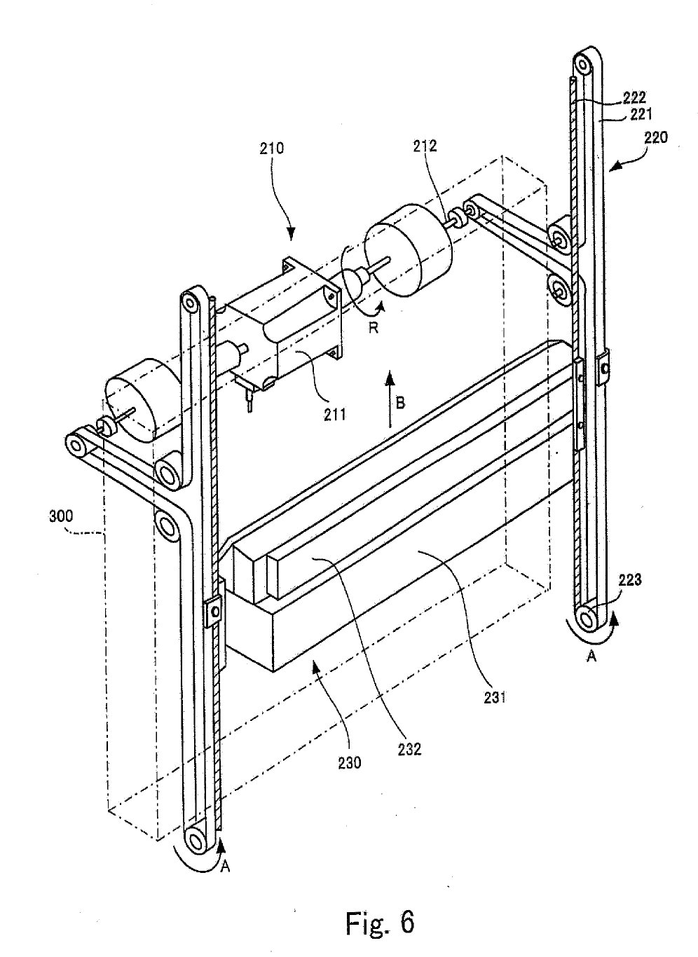

FIG. 6 is an enlarged view of the image reading unit 230, the moving mechanism 220, and the driving source 210, which are shown in FIG. 5.

While the IP holding section 300 (refer to FIG. 5) for holding IP 10 is disposed between the image reading unit 230 and the driving source 210, FIG. 6 shows a state that the image reading unit 230 is removed.

The driving source 210 has a motor 211 for driving a rotary shaft 212. The moving mechanism 220 is installed on right and left both sides of the image reading unit 230 one by one. Each the moving mechanism 220 has a conveying belt 221 coupled with the rotary shaft 212, and a guide rail 222 extending in the vertical direction. The driving source 210 and the moving mechanism 220 have each various sorts of rollers for transmitting the rotary driving force of the motor 211 to the conveying belt 221.

The image reading unit 230 comprises: an image reading section 231 for reading a radiation image which is accumulated and recorded on the IP 10; and an image erasing section 232 for erasing a radiation image remained on the IP after the radiation image is read out. The image reading unit 230 is coupled with the guide rails 222 of the right and left both sides and the conveying belts 221.

When the motor 211 drives the rotary shaft 212 in a direction of the arrow R, the rotary driving force is transmitted to the conveying belt 221, so that the conveying belt 221 circularly moves in a direction of the arrow A. As a result, the image reading unit 230 moves along the guide rails 222 in the upper direction (a direction of the arrow B). When the motor 211 drives the rotary shaft 212 in a direction opposite to the arrow R, the image reading unit 230 is moved in a downward direction.

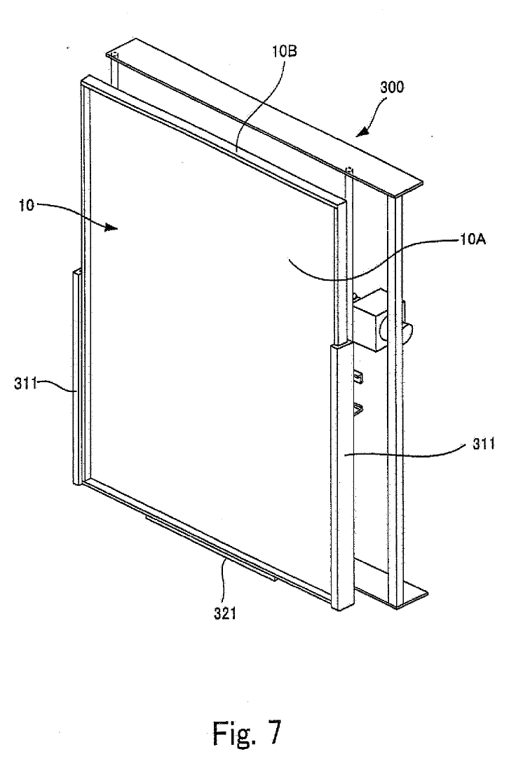

FIG. 7 is an enlarged view of the IP holding section 300 shown in FIG. 5.

As shown in FIG. 7, the IP holding section 300 nips the IP 10 with right and left frames 311 and supports the IP 10 with a bottom frame 321, so that the IP 10 is supported. An adjustment of intervals between the right and left frames 311 and height of the bottom frame 321 makes it possible to hold various sizes of IP. The IP holding section 300 is disposed between the image reading unit 230 and the driving source 210 shown in FIG. 6 in such a manner that a recording surface of the IP 10, on which a radioactive fluorescent material 10A is deposited, turns to the side of the image reading unit 230. The right and left frames 311 and the bottom frame 321 hold a holding frame 10B of the IP 10, and don't disturb the recording surface of the IP 10. This feature makes it possible to efficiently accumulate and record a radiation image on the IP 10. As to the method of adjustments for intervals of frames, it will be described later.

Next, processing for reading a radiation image in the built-in device will be explained in conjunction with FIG. 5.

When taking a picture, the instruction of taking a picture beginning is told from the control device 43 shown in FIG. 4 to the control section 400 of the built-in device 42 shown in FIG. 5, and the control section 400 drives the driving source 210, so that the moving mechanism 220 moves the image reading unit 230 to the starting position P.

A radiation, which is emitted from the radiation projection apparatus 41 and is transmitted through the subject 1, is projected to the IP 10, so that the radioactive fluorescent material 10A of the IP 10 accumulates the radiation energy according to the radiation. Thus, the radiation image of the subject 1 is recorded.

When the radiation image of the subject 1 is recorded, the moving mechanism 220 moves the image reading unit 230 toward the IP 10 downward.

The image reading section 231 of image reading unit 230 has a line light source 231a, a condensing lens array 231b, and a CCD line sensor 231c, which are arranged extending in a depth direction of the figure (a main scanning direction). A laser beam, which is emitted from the line light source 231a, is projected to the IP 10 in the form of a line-like shaped excitation light L extending in the main scanning direction, so that a position of the IP 10, onto which the excitation light L is projected, emits light in accordance with the accumulated radiation energy, and thereby emitting a line-like shaped accelerated phosphorescence emission light R. The accelerated phosphorescence emission light R is condensed by the condensing lens array 231b, and is applied to the CCD line sensor 231c. Thus, it is generated in the form of a digital image.

In the manner as mentioned above, while the radiation image, which is accumulated and recorded in the IP 10, is read in the main scanning direction, the image reading unit 230 is moved downward (a sub-scanning direction), so that the scanning position of the image reading unit 230 is moved in the sub-scanning direction.

The c, which is read through a movement of the image reading unit 230 within a predetermined photography range, is transmitted to the control section 400 and then to the control device 43 shown in FIG. 4.

When reading of the control device 43 is over, the image reading unit 230 moves upward, so that the image erasing section 232 erases the radiation energy remained on the IP 10. The image erasing section 232 has a plurality of fluorescent lamps 232a extending in the main scanning direction (a depth direction of the figure). When the plurality of fluorescent lamps 232a emit erasing lights so as to be projected to the IP 10, the radiation energy remaining on the IP 10 is discharged, so that the radiation image, which is accumulated and recorded on the IP 10, is erased.

The built-in device 42 is basically constructed in the manner as mentioned above.

It is general that the hospital has both the cassette device 30 and the built-in device 42. In the event that the IP 10, which is accommodated in the cassette device 30, is damaged, it is desirable that the IP 10 for the cassette device 30 can be used for the built-in device 42 as it is. Hereinafter, there will be explained various mechanisms and operations for using the IP 10 for the cassette device 30 for the built-in device 42 too.

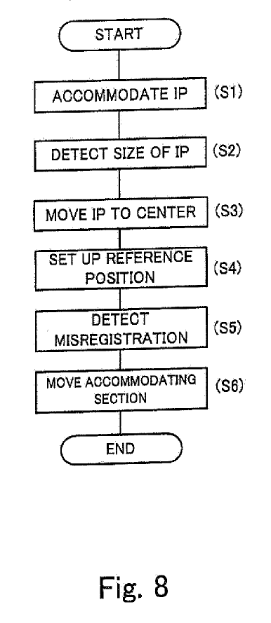

FIG. 8 is a flowchart useful for understanding a series of processing from mounting the IP 10 for the cassette device 30 on the built-in device 42 to the start of the photography.

When the IP 10 of the built-in device 42 is exchanged, a user opens the cover 42f of the accommodating section 42a shown in FIG. 4, takes out IP accommodated by accommodating section 42a, and accommodates the IP 10 for the cassette type in the accommodating section 42a (step Si in FIG. 8).

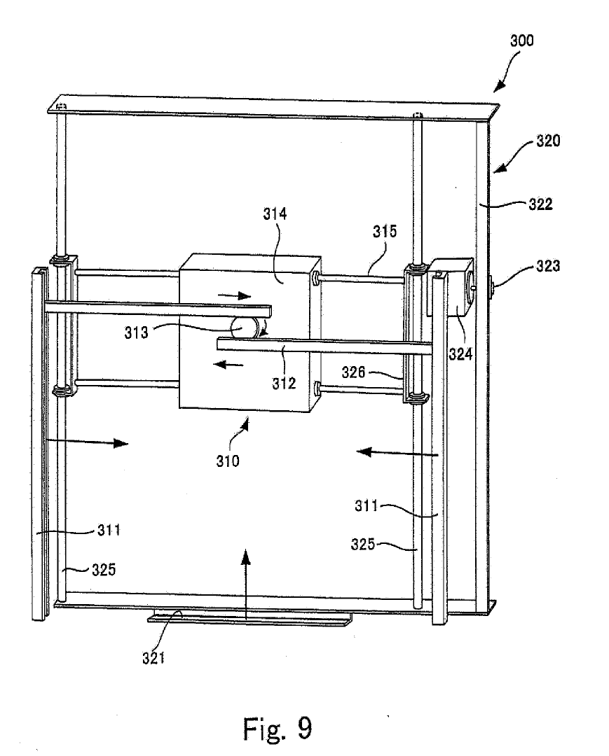

FIG. 9 is a view showing the IP holding section 300 in which no IP is held.

As shown in FIG. 9, the IP holding section 300 comprises a horizontal moving section 310 for moving IP in the horizontal direction, and a vertical moving section 320 for moving IP in the vertical direction.

The horizontal moving section 310 comprises: two right and left frames 311 which nip the IP 10; two rack gears 312 extending from the two right and left frames 311 respectively in direction mutually opposite; a pinion gear 313 that engages in the two rack gears 312 respectively; a driving source 314 that incorporates therein a motor for rotating the pinion gear 313; and a support stick 315 that fixes the driving source 314 on the vertical moving section 320 and supports the driving source 314.

The vertical moving section 320 comprises: a bottom frame 321 that holds the IP 10 at the bottom; a rack gear 322 extending in the vertical direction; a pinion gear 323 that engages with the rack gear 322; a driving source 324 that incorporates therein a motor for rotating the pinion gear 323; a guide stick 325 that vertically leads the movement of the vertical moving section 320; and a coupling member 326 that couples the support stick 315 of the horizontal moving section 310 with the driving source 324 of the vertical moving section 320.

The right and left frames 311 and the bottom frame 321 correspond to an example of the holding frame referred to in the present invention. A combination of the rack gears 312 and 322, the pinion gears 313 and 323, and the driving sources 314 and 324, which are provided on the horizontal moving section 310 and the vertical moving section 320, respectively, corresponds to an example of the first moving mechanism referred to in the present invention. The IP holding section 300 corresponds to an example of the carrier holding section referred to in the present invention.

When a user inserts the IP 10, which is to be newly mounted, downward along the right and left frames 311, the IP 10 is engaged with the bottom frame 321. Subsequently, the user depresses the operation buttons 42e and 43a for IP holding, which are provided on the built-in device 42 and the control device 43, respectively.

When the operation buttons 42e and 43a for IP holding are depressed, the control section 400 shown in FIG. 5 issues a driving instruction to the driving source 314 of the horizontal moving section 310. When the motor of the driving source 314 drives, the pinion gear 313 rotates to horizontally move the two rack gears 312 in direction mutually opposite, so that the interval between the two right and left frames 311 is narrowed. When the right and left frames 311 nip the IP 10, the pinion gear 313 stops the rotation, so that the IP 10 is held in such a manner that the center of its width direction is set to a central position O of the accommodating section 42a (refer to FIG. 4).

The pinion gear 313 has a rotary sensor for detecting the number of revolutions. When the right and left frames 311 have a nip at the IP 10, so that the pinion gear 313 stops the rotation, a detection result of the rotary sensor is transmitted to the control section 400.

As mentioned above, the control section 400 stores the sizes (width and length) of the IP 10 having two or more sizes, which is assumed to be installed in the built-in device 42, and a moving distance in the vertical distance to set the center of its length direction to the central position O in their association. The control section 400 computes the width of the IP10, which is newly mounted on the IP holding section 300, in accordance with the detection result of the rotary sensor, and detects the size of the IP 10 (step S2 in FIG. 8). The control section 400 further obtains the moving distance associated with the detected size, and transmits the obtained moving distance to the driving source 324 of the vertical moving section 320.

In the vertical moving section 320, the motor of the driving source 324 is driven, and the pinion gear 323 engages with the rack gear 322 and rotates, so that the driving source 324, which is coupled with the pinion gear 323, moves vertically. The movement of the driving source 324 is transmitted via the coupling member 326 to the driving source 314 of the horizontal moving section 310. Moreover, the right and left frames 311, which are supported by the driving source 314, and the bottom frame 321, which is engaged in the IP 10 held by the right and left frames 311, are also moved upward by the moving distance transmitted from the control section 400. As a result, the IP 10 held by the IP holding section 300 is moved in such a manner that the center of the height direction of the IP 10 is set to the central position O of the accommodating section 42a (refer to FIG. 4) (step S3 of FIG. 8).

Thus, when the IP 10 is accommodated in the accommodating section 42a, a user operates the operation buttons 42e and 43a of the built-in device 42 and the control device 43 in the state that the radiation projection apparatus 41 projects infrared for projecting position confirmation, and moves the accommodating sections 41a and 42a of the radiation projection apparatus 41 and the built-in device 42 to set the projecting position of the radiation projection apparatus 41 to the central position O of the accommodating section 42a of the built-in device 42.

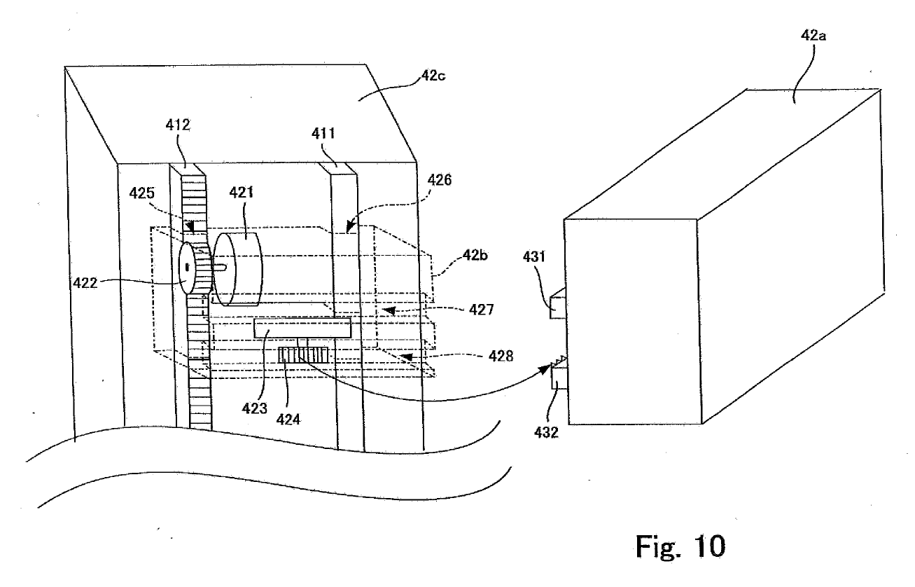

FIG. 10 is a view useful for understanding a mechanism for moving the accommodating section 42a of the built-in device 42.

FIG. 10 shows a box of the moving section 42b with a dashed line in order to make easy to see the motor and the gear accommodated by the moving section 42b, and the rail and the rack gear installed in the supporting section 42c.

The accommodating section 42a is provided with a horizontal rail 431 and a horizontal rack gear 432 which extend in the horizontal direction. The supporting section 42c is provided with a vertical rail 411 and a vertical rack gear 412 which extend in the vertical direction.

The moving section 42b has horizontal grooves 427 and 428 extending in the horizontal direction, which are to be engaged with the horizontal rail 431 and the horizontal rack gear 432 of the accommodating section 42a, respectively, and vertical grooves 425 and 426 extending in the vertical direction, which are to be engaged with the vertical rail 411 and the vertical rack gear 412 of the supporting section 42c, respectively. The moving section 42b further has: a horizontal direction pinion gear 424 that rotates in an engagement with the horizontal rack gear 432 of the accommodating section 42a; a horizontal driving source 423 that accommodates therein a motor for driving the horizontal direction pinion gear 424 and a horizontal sensor for detecting the number of revolution of the horizontal direction pinion gear 424; a vertical direction pinion gear 422 that rotates in an engagement with the vertical rack gear 412 of the supporting section 42c; and a vertical driving source 421 that accommodates therein a motor for driving the vertical direction pinion gear 422 and a vertical sensor for detecting the number of revolution of the vertical direction pinion gear 422. The vertical driving source 421 and the horizontal driving source 423 are controlled by the control section 400 provided in the accommodating section 42a. A combination of the horizontal rack gear 432, the horizontal direction pinion gear 424, and the horizontal driving source 423, and the vertical rack gear 412, the vertical direction pinion gear 422, and the vertical driving source 421 corresponds to an example of the second moving mechanism referred to in the present invention.

When the horizontal driving source 423 is driven, the horizontal direction pinion gear 424 rotates by an engagement with the horizontal rack gear 432 of the accommodating section 42a, so that the accommodating section 42a moves in the horizontal direction. When the vertical driving source 421 is driven, the vertical direction pinion gear 422 rotates by an engagement with the vertical rack gear 412 of the accommodating section 42a, so that the accommodating section 42a moves in the vertical direction.

When the central position of the accommodating section 42a of the built-in device 42 is set to the projection position of the radiation projection apparatus 41, a user depresses the operation button 43a for a reference position determination which is provided on the control device 43.

As mentioned above, the moving sections 41b and 42b of the radiation projection apparatus 41 and the built-in device 42 have the movement sensors (the horizontal sensor and the vertical sensor) for detecting the movement of the accommodating sections 41a and 42a, respectively. When a user depresses the operation button 43a for a reference position determination, the control device 43 obtains the detection results of the movement sensors from the radiation projection apparatus 41 and the built-in device 42, and determines the reference state in accordance with detection result. In other words, the positions of the accommodating sections 41a and 42a of the radiation projection apparatus 41 and the built-in device 42 are determined to the reference positions in which the central position O is set to the projection position of the radiation projection apparatus 41 (step S4 in FIG. 8).

Thus, the preparation before photography is carried out.

When the photography is carried out, first of all, the subject is put on the photography stand 42d of built-in device 42.

Next, a user operates the operation button 43a for a reference position determination, which is provided on the control device 43, to move the accommodating sections 41a of the radiation projection apparatus 41, so that the projection position of the radiation is set to the image taking site of the subject.

The control device 43 receives from the radiation projection apparatus 41 the detection result of the movement sensor in the movement according to the operation of the operation button 43a (step S5 in FIG. 8). The control device 43 computes the moving direction and the moving distance of the accommodating sections 41a of the radiation projection apparatus 41 in accordance with the detection results, and determines the moving direction and the moving distance of the accommodating sections 42a of the built-in device 42 so as to be set to the projection position of the radiation emitted from the radiation projection apparatus 41 in accordance with the computed results. The thus determined moving direction and the moving distance are transmitted to the control section 400 of the built-in device 42.

The control section 400 of the built-in device 42 moves the accommodating section 42a in the moving direction determined by the control device 43 by the moving distance determined by the control device 43 (step S6).

When the accommodating section 42a of the built-in device 42 is moved, the radiation projection apparatus 41 projects the radiation and starts taking a picture. In this condition, the accommodating section 42a of the built-in device 42 moves to the position of the image taking site of the subject, and the central position O of the accommodating section 42a is set to the projecting position of the radiation to be emitted from the radiation projection apparatus 41. Further, the IP 10 installed in the accommodating section 42a is maintained at the central position O. Accordingly, even if the size of the installed IP 10 is small, it is possible to surely project to the IP 10 the radiation transmitted through the image taking site of the subject 1, and thereby accumulating and recording the radiation image.

Thus, according to the present embodiment, the position of the accommodating section 42a of the built-in device 42 is automatically set to the projecting position of the radiation to be emitted from the radiation projection apparatus 41, and the position of the IP 10 installed in the accommodating section 42a is automatically set to the central position O. Therefore, even in the event that IP for cassette is accommodated in the built-in device 42, it is possible to surely take a picture of a desired image taking site.

In the above-mentioned embodiments, there are described the examples in which the rack gears and the pinion gears are used to move the IP and the accommodating section. It is acceptable, however, that the first moving mechanism and the second moving mechanism referred to in the present invention are, for example, ones in which a pole-screw system is used to move the recording carrier and the carrier holding section.

Further, in the above-mentioned embodiments, there are described the examples in which the IP is held to detect the size of the IP. It is acceptable, however, that IC tags, in which the size is recorded on the IP, are applied, and the carrier holding section referred to in the present invention reads the IC tags to detect the size of the IP, and thereby adjusting the intervals among two or more frame members in accordance with the detected size of the IP.

As mentioned above, according to the present invention, it is possible to record a radiation image wherein a desired image taking site is photographed, regardless of the size of the recording carrier.

While the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

What is claimed is:

1. A radiation image recording apparatus comprising:
a carrier holding section having a holding frame provided with two or more frame members that are adjustable in intervals, the holding frame holding a recording carrier, which is now to be used, of recording carriers shaped as a flat plate having two or more sizes on which a radiation image is accumulated and recorded, and a first moving mechanism that moves the holding frame for holding the recording carrier in an in-plane direction in which the recording carrier extends;
a second moving mechanism that moves the holding frame in the in-plane direction;
a first control section that controls the first moving mechanism so that the recording carrier held by the holding frame is disposed in a predetermined position on the carrier holding section; and
a second control section that controls the second moving mechanism so that radiation emitted from a radiation projection apparatus for projecting a radiation toward the carrier holding section is projected to the recording carrier held by the holding frame.

2. The radiation image recording apparatus according to claim 1, wherein the recording carrier has a grip frame that is to be griped by a hand when the recording carrier is mounted on or removed from the holding frame, and the holding frame holds the grip frame of the recording carrier.

3. The radiation image recording apparatus according to claim 1, wherein the first moving mechanism is provided on a back side of a recording surface on which the radiation image is accumulated and recorded, of the recording carrier held by the holding frame.

4. The radiation image recording apparatus according to claim 1, further comprising an image reading section that reads the radiation image accumulated and recorded on the recording carrier in such a manner that an excitation light is projected onto the recording carrier, and light emitted from the recording carrier is read.

5. The radiation image recording apparatus according to claim 4, wherein the image reading section is provided on a side of a recording surface of the recording carrier held by the holding frame, and is withdrawn to a position wherein the recording surface is not blocked off, while the radiation is projected to the recording carrier.
